(19) United States
(12) Patent Application Publication
(10) Pub. No.: US 2009/0083663 A1
(43) Pub. Date: Mar. 26, 2009

(54) APPARATUS AND METHOD FOR RANKING MENU LIST IN A PORTABLE TERMINAL

(75) Inventor: Ji-Sun KIM, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/234,998

(22) Filed: Sep. 22, 2008

(30) Foreign Application Priority Data
Sep. 21, 2007 (KR) 2007-0096700

(51) Int. Cl. G06F 3/048

(52) U.S. Cl. 715/811

(57) ABSTRACT

An apparatus and method for ranking a menu list in a portable terminal are provided. The method includes storing, in an execution record table, execution information regarding at least one of an application and a file, updating a pattern table using information from the execution record table, and ranking a menu list according to information from the updated pattern table.

### PRIORITY

This application claims the benefit under 35 U.S.C. §119(a) to a Korean patent application filed in the Korean Intellectual Property Office on Sep. 21, 2007 and assigned Serial No. 2007-96700, the entire disclosure of which is hereby incorporated by reference.

### BACKGROUND OF THE INVENTION

1. Field of the Invention

The present invention relates to an apparatus and method for controlling a menu list in a portable terminal. More particularly, the present invention relates to an apparatus and method for recognizing a use pattern and ranking a menu list accordingly.

2. Description of the Related Art

In recent years, portable terminals have evolved from supporting only simple, single key functions to supporting several complex functions.

With the increased use of portable terminals, service providers and terminal manufacturers have been developing terminals that have more convenient functions in order to attract even more users. Accordingly, portable terminals now provide a variety of supplementary functions, for example, a phone book, games, a Short Message Service (SMS), Internet access, e-mail access, mobile banking and the like.

In order to access these supplementary functions, a portable terminal composes and provides a menu. In general, the composition of the menu including an order of menu items is determined by terminal manufacturers and must be used without alteration. Alternatively, a portable terminal may allow a user to change the rank of menu items by manually reordering the items using a move or other function.

However, in a portable terminal having a menu list whose sequence is unilaterally determined by the terminal manufacturer, the terminal always provides the same menu irrespective of a user's menu use pattern. Thus, accessibility of the terminal's functions and convenience of use deteriorate for the user. Also, if a user is able to reorganize a menu list, it requires one by one movement of the menu items using the move function which is also an inconvenience for the user.

Also, the portable terminals use a method for, upon next execution, allowing a user to use the same menu with the minimum key press by focusing the latest used menu irrespective of user's intention. However, there is a problem of requiring several times of key press to next execute an item located far from the latest used item.

### SUMMARY OF THE INVENTION

An aspect of the present invention is to address at least the above-mentioned problems and/or disadvantages and to provide at least the advantages described below. Accordingly, one aspect of the present invention is to provide an apparatus and method for ranking a menu list in a portable terminal.

Another aspect of the present invention is to provide an apparatus and method for calculating a use pattern in a portable terminal.

A further aspect of the present invention is to provide an apparatus and method for recognizing a use pattern and ranking a menu list in a portable terminal.

The above aspects are achieved by providing an apparatus and method for ranking a menu list in a portable terminal.

According to one aspect of the present invention, a method for ranking a menu list according to a use pattern in a portable terminal is provided. The method includes storing, in an execution record table, execution information regarding at least one of an application and a file, updating a pattern table using information from the execution record table, and ranking a menu list according to information from the updated pattern table.

According to another aspect of the present invention, an apparatus for ranking a menu list according to a use pattern in a portable terminal is provided. The apparatus includes a controller and a memory. The controller controls a function of storing, in an execution record table, execution information regarding at least one of an application or file, for updating a pattern table using information from the execution record table, and for ranking a menu list according to information from the updated pattern table. The memory stores the execution record table and updated pattern table under control of the controller.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings in which:

FIG. 1 is a block diagram illustrating a construction of a portable terminal for ranking a menu list according to an exemplary embodiment of the present invention;

FIG. 2 is a flow diagram illustrating a process of storing an execution record table according to an exemplary embodiment of the present invention;

FIG. 3 is a flow diagram illustrating a process of storing a pattern table according to an exemplary embodiment of the present invention;

FIG. 4 is a flow diagram illustrating a process of ranking a menu list according to an exemplary embodiment of the present invention;

FIG. 5 is a diagram illustrating a screen applying a shortcut according to a use pattern to a background picture in a portable terminal according to an exemplary embodiment of the present invention; and

FIGS. 6A and 6B are diagrams illustrating screens of providing a use pattern in a portable terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary apparatus and method for recognizing a pattern of use of an application, file and the like by analyzing an execution record and for ranking a menu list according to the pattern of use are described below.

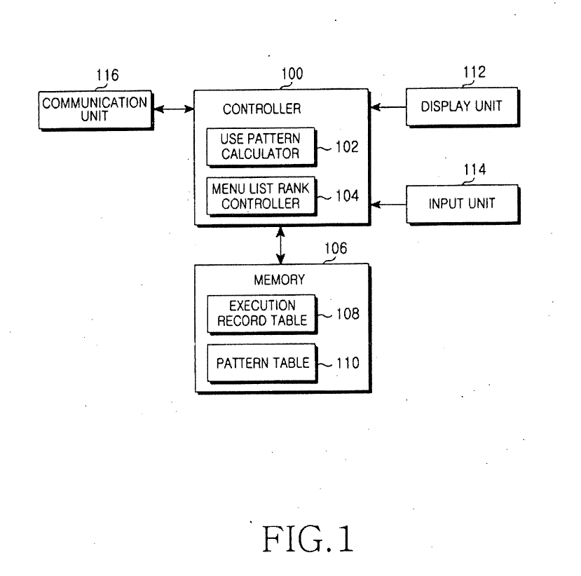

FIG. 1 is a block diagram illustrating a construction of a portable terminal for ranking a menu list according to an exemplary embodiment of the present invention. The portable terminal may include a controller 100, a use pattern calculator 102, a menu list rank controller 104, a memory 106, an execution record table 108, a pattern table 110, a display unit 112, an input unit 114, a communication unit 116 and the like.

Referring to FIG. 1, the controller (i.e., a Micro-Processor Unit (MPU)) 100 controls a general operation of the portable terminal. According to an exemplary embodiment of the present invention, a use pattern recognition function may be turned ‘ON’ in the portable terminal. When the use pattern recognition function is ‘ON’ and a user executes general functions of the portable terminal, the controller 100 performs a function of storing execution information about an application, a file and the like executed before a pattern calculation time. The execution information may include data about the day or hour at which the execution takes place, the duration of the execution, the program path associated with the execution, the number of times the execution has been performed and the like. The information may be stored in the execution record table 108 shown in Table 1 below. Furthermore, if the MPU determines that an execution record table 108 does not yet exist, the controller 100 generates the execution record table 108.

TABLE 1

| | | Minute | |
|---|---|---|---|
| Day | Hour | (Execution time) | Program path |
| Mon. | 07 | 0 | \\windows\\window media.exe |
| Mon. | 08 | 0 | \\windows\task.exe |

. . .

| | | | |
|---|---|---|---|
| Mon. | 19 | 0 | \\windows\\bubble breaker.exe |
| Tue. | 08 | 10 | \\windows\\task.exe |

. . .

| | | | |
|---|---|---|---|
| Wed. | 08 | 5 | \\windows\\task.exe |
| Wed. | 15 | 30 | \\windows\\bubble breaker.exe |

. . .

| | | | |
|---|---|---|---|
| Sat. | 12 | 0 | \\windows\\bubble breaker.exe |
| Sat. | 15 | 15 | \\windows\\window media.exe |

. . .

| | | | |
|---|---|---|---|
| Sun. | 13 | 0 | \\windows\\window media.exe |
| Sun. | 15 | 30 | \\windows\\window media.exe |

The controller 100 includes the use pattern calculator 102. At the pattern calculation time, the use pattern calculator 102 reads data from the execution record table 108, compares the read data of the execution record table 108 with data of the pattern table 110, and updates the pattern table 110 based on the result of the comparison. In an exemplary embodiment, the data read from the execution record table 108 is a row or column of data that is read and compared one by one with a row or column of data of the pattern table 110. In another exemplary embodiment, the controller 100 may continuously perform an operation of updating the pattern table 110. That is, the controller 100 may continuously read data of the execution record table 108, compare the read data with data from the pattern table 110, update the pattern table 110 based on the comparison, and delete the read data of the execution record table 108 until the data of the execution record table 108 is all deleted. Furthermore, the controller 110 may newly generate a pattern table 110 if it is determined that there is no pattern table 110 by the use pattern calculator 102.

The updating of the pattern table 110 is implemented by comparing the read data of the execution record table 108 with data of the pattern table 110. If the read data from the execution record table 108 does not match data in the pattern table 110, the read data is newly created in the pattern table 110 and if the read data matches data in the pattern table 110, the existing data in the pattern table 110 is updated with the read data. For example, when a row of data is read from the execution record table 108 and there is no row having the same day, hour, and program path in the pattern table 110, a new column is generated and stored in the pattern table 110. Alternatively, when there is a row having the same day, hour, and program path in the pattern table 110, the row is updated by increasing the number of execution times by ‘1’ and calculating a new execution average time.

For example, when an existing pattern table 110 of Table 2 below is updated using the execution record table 108 of Table 1, data is read from the execution record table 108 and compared with data in the pattern table 110. In this example, because there is no row in Table 2 having the same day, hour, and program path as data of a first row of the execution record table 108 of Table 1, a new row is generated and added as reflected in Table 3 below. Also, the first row of the execution record table 108 of Table 1 is deleted.

As the updating of pattern table 110 (Table 2) continues, the next data, for example the second row, is read. Because there is a row in Table 2 having the same day, hour, and program path as data of the second row of the execution record table 108 of Table 1, the “number of times” data corresponding to that row is increased by ‘1’ and an average value is newly calculated and updated. In an exemplary implementation, the average value is calculated by (number of times for pattern table×minute (average) for pattern table+minute (execution time) for execution record table)÷(number of times for pattern table+1) as shown in the corresponding row of Table 3 below.

TABLE 2

| | | | Min. | |
|---|---|---|---|---|
| Day | Hour | No. of times | (Average) | Program path |
| Mon. | 08 | 10 | 05 | \\windows\task.exe |

. . .

| | | | | |
|---|---|---|---|---|
| Tue. | 08 | 05 | 02 | \\windows\\task.exe |

. . .

| | | | | |
|---|---|---|---|---|
| Sun. | 13 | 02 | 05 | \\windows\\window media.exe |
| Sun. | 15 | 05 | 25 | \\windows\\window media.exe |

TABLE 3

| | | No. of | Min. | | |
|---|---|---|---|---|---|
| Day | Hour | times | (Average) | Program path | Remarks |
| Mon. | 07 | 01 | 00 | \\windows\window | Add |
| | | | | media.exe | |
| Mon. | 08 | 11 | 04 | \\windows\task.exe | Change |

. . .

| | | | | |
|---|---|---|---|---|
| Tue. | 08 | 05 | 02 | \\windows\\task.exe |

. . .

| | | | | |
|---|---|---|---|---|
| Sun. | 13 | 02 | 05 | \\windows\\window |
| | | | | media.exe |
| Sun. | 15 | 05 | 25 | \\windows\\window |
| | | | | media.exe |

The controller 100 also includes the menu list rank controller 104. Using the menu list rank controller 104, the controller 100 processes a function of ranking data to produce a menu list. The ranking of data to produce a menu list may be accomplished in several ways. For example, if menu list ranking is processed using a first setup option, the controller 100 searches the updated pattern table 110 and changes a rank of items composing a menu according to a use and time pattern. Here, the changing of the rank of items composing a menu according to the use and time pattern indicates that the pattern table is searched for one or more rows having the same value as a day and hour of the time when the user generates an input for outputting the menu list. Based on the search results, the controller composes a menu having items listed in sequence corresponding to the number of times of execution with the highest priority given the most executed application or file among the searched rows. In the above example, the pattern table was searched with a focus on the day and hour corresponding to the day and hour that the user generated an input for outputting a menu list. Of course, in the process of ranking data to produce a menu list, the pattern table may be searched with a focus on the day alone, the hour alone, or any of the other variables in the pattern table.

For example, if the menu list ranking is processed using a second setup option, the controller 100 can search the pattern table with a focus on the most executed application or file and compose a menu having applications or files listed in a sequence corresponding to the number of times they were executed. If the items are listed with the highest priority given to the most executed application or file, it allows for selection of the most executed application or file by a minimum amount of input by the user, for example a minimum number of key presses. Alternatively, if the menu list ranking is processed using a third setup option, the controller 100 processes a function of composing and outputting a menu in regular sequence made by a user.

The memory 106 stores a program for controlling a general operation of the portable terminal, temporary data generated during an operation of the portable terminal, a system parameter, and other storage data. Also, the memory 106 stores the execution record table 108 and pattern table 110 under the control of the controller 100 according to an exemplary embodiment of the present invention.

The display unit 112 displays state information generated during operation of the portable terminal including numerals, characters and the like. Also, the display unit 112 outputs a menu list according to the use pattern under the control of the controller 100 according to an exemplary embodiment of the present invention. The display unit 112 may be provided as a Liquid Crystal Display (LCD). In this case, the display unit 112 may include a controller for controlling the LCD, a video memory in which image data is stored and an LCD element. If the LCD is provided as a touch screen, the display unit 112 may perform a part or all of the functions of the input unit 114.

The input unit 114 includes keys for inputting numeral and character information, function keys for setting and executing functions, and the like. The input unit 114 outputs signals corresponding to keys pressed by the user to the controller 100. Also, the input unit 114 outputs signals corresponding to key presses for menu list ranking to the controller 100 according to an exemplary embodiment of the present invention.

The communication unit 116 transmits/receives and processes a radio signal that is input/output through an antenna under the control of the controller 100. For example, in a transmission mode, the communication unit 116 converts a baseband signal obtained by channel-coding and spreading data to be transmitted into a Radio Frequency (RF) signal and transmits the converted signal through the antenna. In a reception mode, the communication unit 116 converts a received RF signal into a baseband signal, despreads and channel-decodes the baseband signal, and restores data.

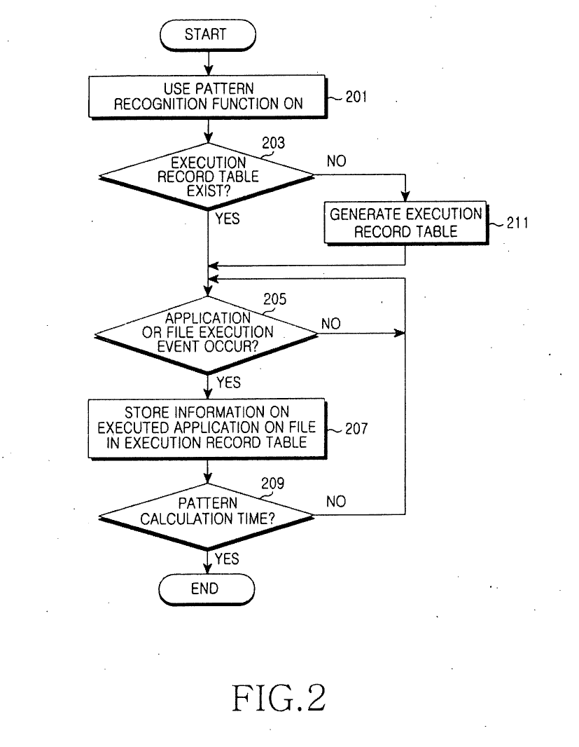

FIG. 2 is a flow diagram illustrating a process of storing an execution record table according to an exemplary embodiment of the present invention.

Referring to FIG. 2, a use pattern recognition function is turned ‘ON’ in step 201. In step 203, the portable terminal determines if an execution record table exists.

If it is determined that an execution record table does not exist, the portable terminal generates an execution record table in step 211 and proceeds to step 205.

If it is determined that an execution record table does exist, the portable terminal determines if an application or file execution event occurs in step 205. If it is determined that the application or file execution event occurs, the portable terminal stores execution information on the executed application or file in the execution record table in step 207. In contrast, if it is determined that the application or file execution event does not occur, the portable terminal repeatedly performs step 205.

The portable terminal determines if a preset pattern calculation time occurs in step 209. The pattern calculation time can be set by a user, can be preset at a factory and later changed by a user as desired, can be set to occur after each execution event and can be set by time, by date, by period and the like. If it is determined that the preset pattern calculation time has not occurred, the portable terminal returns to step 205 and repeatedly performs step 205 and subsequent steps. If it is determined that the preset pattern calculation time does occur, the portable terminal finishes storage of the execution record table and terminates the process according to an exemplary embodiment of the present invention.

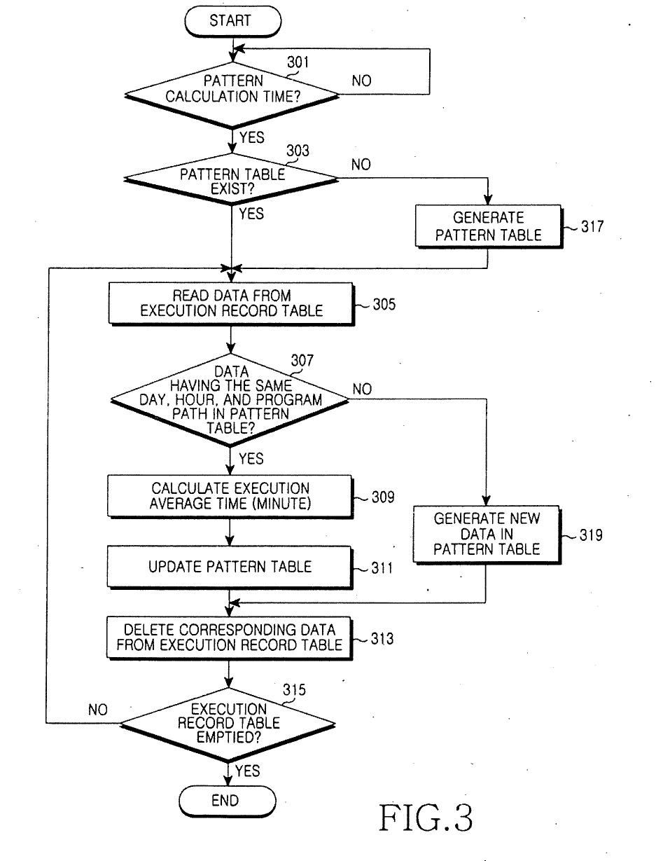

FIG. 3 is a flow diagram illustrating a process of storing a pattern table to recognize a use pattern according to an exemplary embodiment of the present invention.

Referring to FIG. 3, it is determined if a pattern calculation time occurs in step 301. In an exemplary implementation, the determining if a pattern calculation time occurs may also include determining if storage of an execution record table is finished. If it is determined in step 301 that the pattern calculation time occurs, the portable terminal determines if there is a pattern table in step 303. If it is determined that a pattern table does not exist, the portable terminal generates the pattern table in step 317 and proceeds to step 305. Alternatively, if it is determined that a pattern table exists in step 303, the portable terminal proceeds to step 305.

In step 305, the portable terminal reads data from the execution record table. In an exemplary implementation, the portable terminal reads one row of data from the execution record table in step 305. In step 307, the portable terminal determines if there is data in the pattern table having the same day, time, and program path as the data read from the execution record table. If it is determined that data having the same day, time and program path does not exist in the pattern table, the portable terminal proceeds to step 319 where it generates a new row in the pattern table and populates the row with information from the read row.

If it is determined in step 307 that data having the same day, time and program path does exists in the pattern table, the portable terminal calculates an execution average time (minute) in step 309 and updates the pattern table by the calculated average time in step 311.

Then, the portable terminal deletes the corresponding data in the execution record table in step 313, having updated the pattern table, and determines if all data of the execution record table is deleted in step 315.

If the data of the execution record table is not all deleted, the portable terminal returns to step 305 and repeatedly performs step 305 and its subsequent steps.

If all data of the execution record table is deleted, the portable terminal terminates the process according to an exemplary embodiment of the present invention.

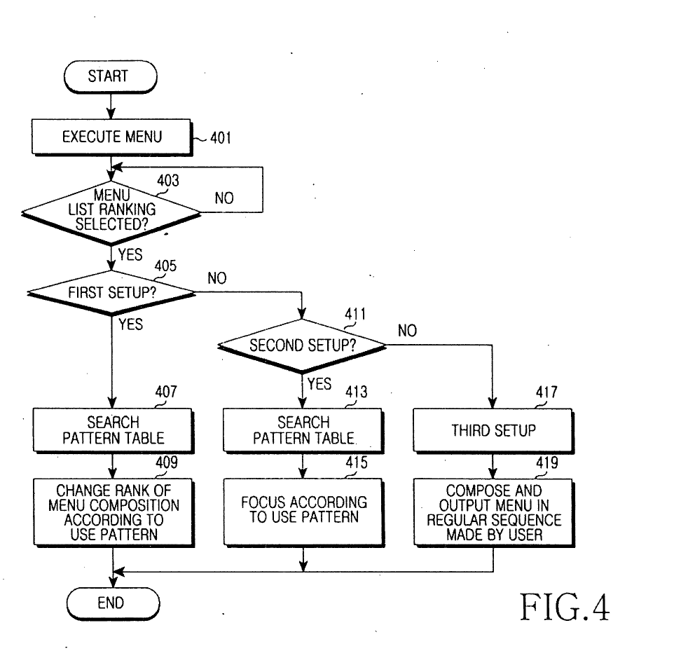

FIG. 4 is a flow diagram illustrating a process of ranking a menu list according to an exemplary embodiment of the present invention.

Referring to FIG. 4, a menu is executed in step 401. For example, the menu may be executed by a user pressing a key for outputting a menu list. In step 403, the portable terminal determines if menu list ranking is set by the user. In an exemplary embodiment, the setting of the menu list ranking may have been previously performed by the user or set at the factory. Alternatively, menu list ranking may be set in step 403. If the menu list ranking is not set by the user, the portable terminal continues with step 403 until menu list ranking is set by the user. Alternatively, if it is determined that the menu list ranking is set by the user in step 403, the portable terminal determines if menu list ranking is to proceed using a first setup option in step 405.

If it is determined in step 405 that the menu list ranking is a first setup, the portable terminal searches the pattern table in step 407. In step 409, the portable terminal changes a rank of items composing a menu according to a use and time pattern. Here, the changing of the rank of items composing a menu according to the use and time pattern indicates that the pattern table is searched for one or more rows having the same value as a day and hour of the time when the user generates an input for outputting a menu list. Based on the search results, the controller composes a menu having items listed in sequence corresponding to the number of times of execution with the highest priority given the most executed application or file among the searched row.

If it is determined in step 405 that the menu list ranking is not to be processed according to a first setup option, the portable terminal determines if the menu list ranking is a second setup in step 411.

If it is determined in step 411 that the menu list ranking is to proceed using a second setup option, the portable terminal searches the pattern table in step 413. In step 415, the portable terminal focuses on the most executed application or file according to the searched pattern table. Here, the portable terminal can focus on the most executed application or file and allow a selection of the most executed application or file by a minimum amount of input by the user, thus increasing the user's convenience.

If it is determined in step 411 that the menu list ranking is not the second setup, the portable terminal determines that the menu list ranking is to proceed using a third setup option in step 417 and composes and outputs a menu in regular sequence made by a user in step 419.

Then, the portable terminal terminates the process according to an exemplary embodiment of the present invention.

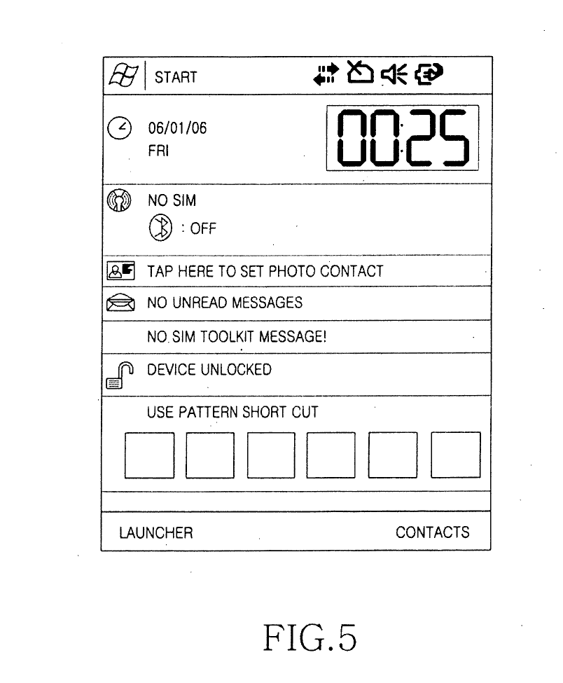

FIG. 5 is a diagram illustrating a screen applying a shortcut according to a use pattern according to an exemplary embodiment of the present invention.

The above description is a method for composing a menu list using a use pattern. However, as illustrated in FIG. 5, the use pattern can also be used to provide a shortcut list of frequently used applications or files. For example, the pattern table may be searched with a focus on the most frequently used applications or files. Based on the search results, a list of the most frequently used applications and/or files may be generated and, based on the generated list, a shortcut list may be generated and displayed. The shortcut list may be displayed as, for example, a set of icons corresponding to frequently used applications, a memory path corresponding to a location of a file and the like and may be displayed as a background screen when the phone is in a standby mode or may be displayed when requested by the user. Furthermore, the shortcut list may be provided to a scheduling program such a Today Plug-In. By listing the most frequently used programs on a shortcut list or scheduler, the user is able to access a desired application or file more quickly.

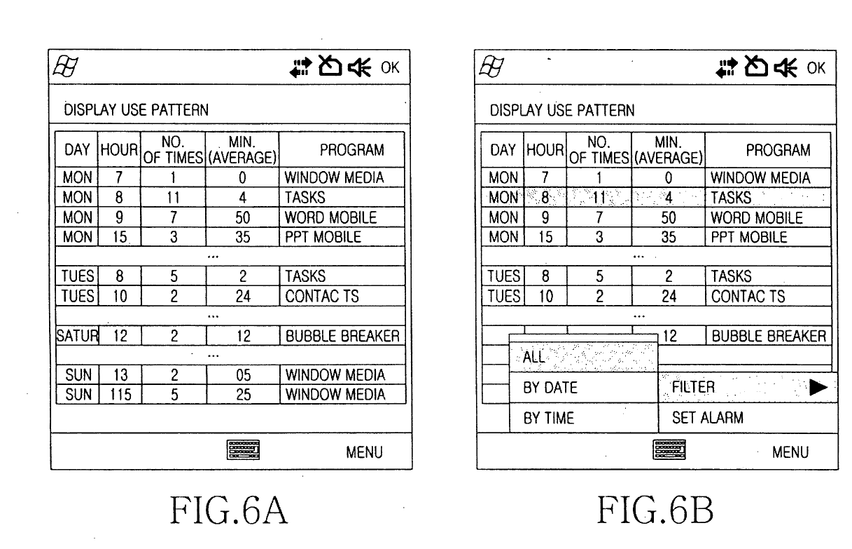

FIGS. 6A and 6B are diagrams illustrating screens of providing a use pattern according to an exemplary embodiment of the present invention.

As illustrated in FIG. 6A, in an exemplary embodiment of the present invention, the portable terminal can also provide a function of allowing a user to directly identify a use pattern so that the user can directly understand his/her own pattern. Upon identifying the use pattern, the user may specify a filter and identify a frequently used function by date, time and the like.

As illustrated in FIG. 6B, in an exemplary embodiment of the present invention, the portable terminal can also provide a function of setting an alarm to automatically execute a desired item among the use pattern. For example, if a user checks a daily task every day by executing the function ‘Tasks’ at 8 o'clock and ‘Tasks’ execution information is stored in a use pattern, the alarm may be set to ‘Tasks’ such that the ‘Tasks’ can be automatically executed everyday at 8 o'clock. Alternatively, a ‘Tasks’ option may be generated with a popup everyday at 8 o'clock so that the user may directly execute the ‘Tasks’ upon the alarm.

As described above, an exemplary embodiment of the present invention has an effect of calculating a use pattern at certain times and ranking a menu list in a portable terminal, thereby being capable of removing an inconvenience that a user has to change the menu list rank one by one, restricting an unnecessary function using a variety of setup functions, and applying a use pattern more quickly and easily suitable to a user's preference.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for ranking a menu list according to a use pattern in a portable terminal, the method comprising:
storing, in an execution record table, execution information regarding at least one of an application and a file;
updating a pattern table using information from the execution record table; and
ranking a menu list according to information from the updated pattern table.

2. The method of claim 1, wherein the storing of the execution information comprises storing at least one of a day of execution, a time of execution, an execution duration, a number of times of execution and program information.

3. The method of claim 2, wherein the updating of the pattern table using the information from the execution record table comprises:
reading data from the execution record table;
comparing the data read from the execution record table with data of the pattern table;
determining if data read from the execution record table includes at least one of the same day, hour, and program path as the data of the pattern table; and
if there is data having at least one of the same day, hour, and program path as the data in the pattern table, increasing a number of times of execution of the application or file corresponding to the data by ‘1’, calculating an average execution time of the corresponding application or file, and updating the pattern table.

4. The method of claim 3 wherein the reading of the data from the execution record table comprises reading a row of data.

5. The method of claim 4, further comprising, if there is no row of data having at least one of the same day, hour, and program path in the pattern table, generating a new row of data in the pattern table corresponding to the row of data read from the execution record table and updating the pattern table.

6. The method of claim 3, further comprising, if the pattern table is updated using the execution record table, deleting the data from the execution record table read to update the pattern table.

7. The method of claim 2, wherein the ranking of the menu list according to information from the updated pattern table comprises:
receiving input, at a first day and hour, for generating a menu list;
searching the pattern table for data corresponding to the first day and hour; and
arranging the data in descending order depending on the number of times of execution.

8. The method of claim 2, wherein the ranking of the menu list according to information from the updated pattern table comprises:
receiving input, at a first day and hour, for generating a menu list;
searching the pattern table for data corresponding to the first day and hour; and
arranging the data in order according to the most executed application or file.

9. The method of claim 1, further comprising:
searching the pattern table for a frequently used application or file; and
providing the frequently used application or file to at least one of a Today Plug-In and a background picture.

10. The method of claim 1, further comprising setting an alarm to a desired item in the updated pattern table to automatically execute a corresponding function at a specified day and time.

11. An apparatus for ranking a menu list according to a use pattern in a portable terminal, the apparatus comprising:
a controller for controlling a function of storing, in an execution record table, execution information regarding at least one of an application and a file, for updating a pattern table using information from the execution record table, and for ranking a menu list according to information from the updated pattern table; and
a memory for storing the execution record table and the updated pattern table under control of the controller.

12. The apparatus of claim 11, wherein the execution information comprises at least one of a day of execution, a time of execution, an execution duration, a number of times of execution and program information.

13. The apparatus of claim 12, wherein the controller controls a function of reading data from the execution record table, comparing the data read from the execution record table with data of the pattern table, determining if data read from the execution record table includes at least one of the same day, hour, and program path as the data of the pattern table, and, if there is data having at least one of the same day, hour, and program path as the data in the pattern table, increasing a number of times of execution of the application or file corresponding to the data by ‘1’, calculating an average execution time of the corresponding application or file, and updating the pattern table.

14. The apparatus of claim 13 wherein the reading of the data from the execution record table comprises reading a row of data.

15. The apparatus of claim 14, wherein the controller controls a function of, if there is no row data having at least one of the same day, hour, and program path in the pattern table, generating a new row of data in the pattern table corresponding to the row of data read from the execution record table and updating the pattern table.

16. The apparatus of claim 12, wherein the controller controls a function of, if the pattern table is updated using the execution record table, deleting the data from the execution record table read to update the pattern table.

17. The apparatus of claim 12, wherein the ranking of the menu list according to information from the updated pattern table comprises receiving input, at a first day and hour, for generating a menu list, searching the pattern table for data corresponding to the first day and hour, and arranging the data in descending order depending on the number of times of execution.

18. The apparatus of claim 12, wherein the ranking of the menu list according to information from the updated pattern table comprises receiving input, at a first day and hour, for generating a menu list, searching the pattern table for data corresponding to the first day and hour, and arranging the data in order according to the most executed application or file.

19. The apparatus of claim 12, wherein the pattern table is searched for a frequently used application or file and the frequently used application or file is provided to at least one of a Today Plug-In and background picture.

20. The apparatus of claim 11, wherein an alarm is set to a desired item in the updated pattern table to automatically execute a corresponding function at a specified day and time.
